(19) United States
(12) Patent Application Publication
(10) Pub. No.: US 2007/0229003 A1
(43) Pub. Date: Oct. 4, 2007

(54) Field emission type backlight unit and method of manufacturing the same

(76) Inventors: Shang-Hyeun Park, Boryeong-si (KR); Chan-Wook Baik, Seongnam-si (KR); Jeong-Hee Lee, Seongnam-si (KR); Yong-Wan Jin, Seoul (KR)

Correspondence Address: Robert E. Bushnell, Suite 300, 1522 K. Street, N.W., Washington, DC, 20005-1202, US

(21) Appl. No.: 11/510,580

(22) Filed: Aug. 28, 2006

(30) Foreign Application Priority Data
Apr. 4, 2006 (KR) 10-2006-0030498

(51) Int. Cl. H01J 1/02; H01J 9/02

(52) U.S. Cl. 315/324; 445/51

(57) ABSTRACT

A field emission type backlight unit and a method of manufacturing the same. The field emission type backlight unit includes a lower substrate, a plurality of cathode electrodes formed on the lower substrate, a plurality of insulating layers formed in a line shape on the lower substrate and the cathode electrodes, a plurality of gate electrodes formed on the insulating layers, and at least one emitter formed of an electron emission material on each cathode electrode between the insulating layers.

### CLAIM OF PRIORITY

This application makes reference to, incorporates the same herein, and claims all benefits accruing under 35 U.S.C. § 119 from an application for FIELD EMISSION TYPE BACKLIGHT UNIT AND METHOD OF MANUFACTURING THE SAME earlier filed in the Korean Intellectual Property Office on 4 Mar. 2006 and there duly assigned Serial No. 10-2006-0030498.

### BACKGROUND OF THE INVENTION

1. Field of the Invention

The present invention relates to a field emission type backlight unit and a method of manufacturing the same, and more particularly, to a field emission type backlight unit that has an increased brightness and luminous efficiency and a method of manufacturing the same.

2. Description of the Related Art

Flat panel display devices can typically be classified into light emitting type display devices and light receiving type display devices. Light emitting type display devices include cathode ray tubes (CRTs), plasma display panels (PDPs), and field emission display (FED) devices, and light receiving type display devices include liquid crystal display (LCD) devices. LCD devices have the advantages of being light weight and having low power consumption, but the drawback of being a light receiving type display device. That is, LCD devices cannot generate their own light and thus need to use external light to display images. Therefore, the images cannot be seen in a dark place. To address this disadvantage, a backlight unit is installed on a rear surface of LCD devices.

Conventional backlight units mainly use cold cathode fluorescent lamps (CCFLs) for a line light source and light emitting diodes (LEDs) for a point light source. However, conventional backlight units have high manufacturing costs due to their structural complexity, and high power consumption due to light reflection and transmittance of the generated light from sides of the backlight units. In particular achieving uniform brightness of the generated light is becoming more difficult as the size of LCD devices increase.

Recently, to address the above drawbacks, field emission type backlight units having a surface light emitting structure have been developed. The field emission type backlight units have lower power consumption than the backlight units that use the conventional CCFLs, and are advantageous as they have relatively uniform brightness over a wide light emitting region. The field emission type backlight unit can be used for illumination. However, the method of manufacturing the field emission type backlight unit is very complicated.

### SUMMARY OF THE INVENTION

The present invention provides a field emission type backlight unit that has an increased brightness and luminous efficiency and can be readily manufactured.

According to an aspect of the present invention, there is provided a field emission type backlight unit comprising: a lower substrate; a plurality of cathode electrodes formed on the lower substrate; a plurality of insulating layers formed in a line shape on the lower substrate and the cathode electrodes; a plurality of gate electrodes formed on the insulating layers; and at least one emitter formed of an electron emission material on the cathode electrodes between the insulating layers.

The cathode electrodes may be parallel to each other, and the insulating layers may cross the cathode electrodes.

The insulating layers may have a height of 3 to 10 μm, and a gap of 10 to 30 μm therebetween. The emitter may have a height of 1 to 3 μm.

The electron emission material may be formed of at least one selected from the group consisting of carbon nanotubes (CNTs), ZnO (zinc oxide), amorphous carbon, nano diamond, nano metal wire, and nano oxide metal wire.

The field emission type backlight unit may further comprise an upper substrate spaced a predetermined distance from the lower substrate, an anode electrode formed on a lower surface of the upper substrate, and a phosphor layer formed on the anode electrode.

According to an aspect of the present invention, there is provided a method of manufacturing a field emission type backlight unit, comprising: forming a plurality of cathode electrodes on a substrate; forming a plurality of insulating layers in a line shape on the substrate and the cathode electrodes; forming a plurality of gate electrodes on the insulating layers; and forming at least one emitter formed of an electron emission material on the cathode electrodes between the insulating layers.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partially exploded perspective view of a field emission type backlight unit;

FIG. 2 is a cross-sectional view of the field emission type backlight unit of FIG. 1;

FIG. 3 is a partially exploded perspective view of a field emission type backlight unit according to an embodiment of the present invention;

FIG. 4 is a cross-sectional view of the field emission type backlight unit of FIG. 3, according to an embodiment of the present invention;

FIG. 5 is a schematic drawing showing initial divergence angles of electrons emitted from a conventional field emission type backlight unit;

FIG. 6 is a schematic drawing showing initial divergence angles of electrons emitted from a field emission type backlight unit according to an embodiment of the present invention; and

FIGS. 7 through 14 are cross-sectional views illustrating a method of manufacturing a field emission type backlight unit according to an embodiment of the present invention.

### DETAILED DESCRIPTION OF THE INVENTION

The present invention will now be described more fully with reference to the accompanying drawings in which exemplary embodiments of the invention are shown. Like reference numerals refer to like elements throughout the drawings.

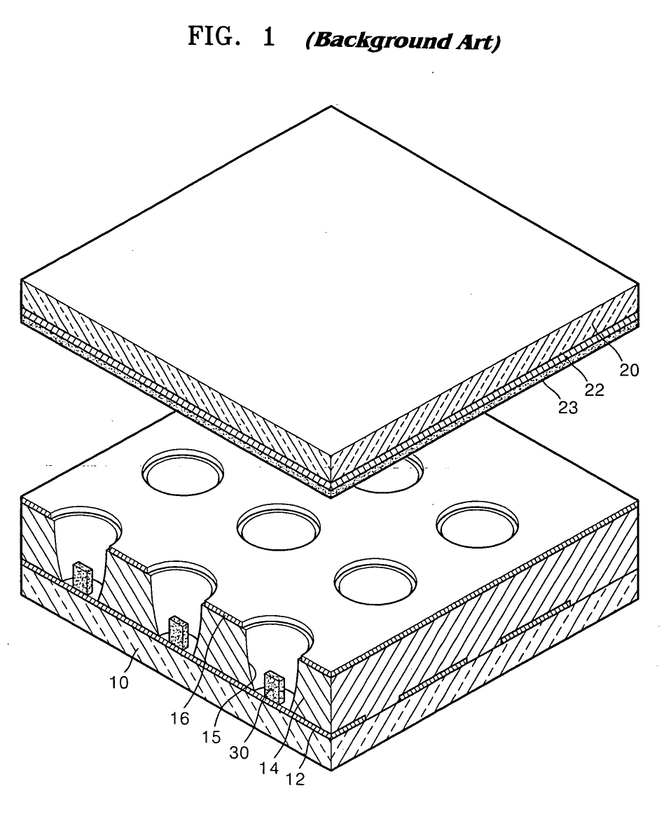

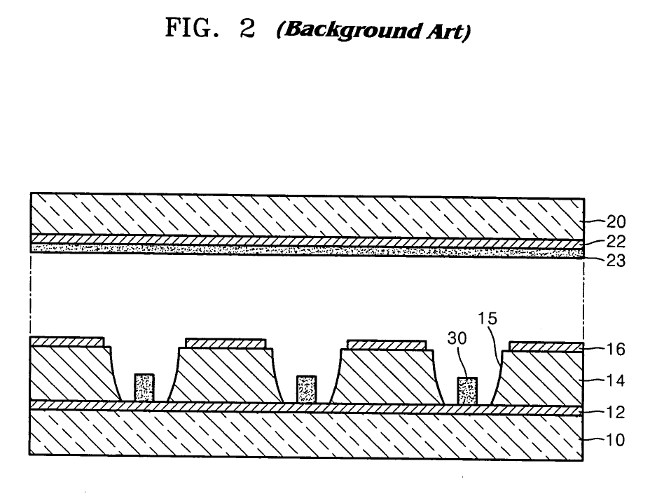

FIG. 1 is an example of a partially exploded perspective view of a field emission type backlight unit and FIG. 2 is a cross-sectional view of the field emission type backlight unit of FIG. 1.

Referring to FIGS. 1 and 2, an upper substrate 20 and a lower substrate 10 face each other separated by a predetermined distance. Here, a predetermined distance between the upper substrate 20 and the lower substrate 10 is maintained by spacers (not shown) formed therebetween.

A cathode electrode 12 is formed on an upper surface of the lower substrate 10, and an insulating layer 14 and a gate electrode 16 for extracting electrons are sequentially formed on the cathode electrode 12. Emitter holes 15 for exposing the cathode electrode 12 are formed in the insulating layer 14.

Emitters 30, formed of an electron emitting material such as carbon nanotubes (CNTs), are formed on the cathode electrode 12 which is exposed through the emitter holes 15.

An anode electrode 22 is formed on a lower surface of the upper substrate 20, and a phosphor layer 23 is coated on the anode electrode 22.

In the above structure, electrons are emitted from the emitters 30 by applying a voltage between the gate electrode 16 and the cathode electrode 12, and the electrons accelerated toward the anode electrode 22 excite the phosphor layer 23 to emit visible light.

However, the field emission type backlight unit having the above structure has low brightness and low luminous efficiency due to a small initial divergence angle of the electrons emitted from the emitters 30. Also, the method of manufacturing the above field emission type backlight unit includes: forming the cathode electrode 12 and the insulating layer 14 on the lower substrate 10; forming the gate electrode 16 by patterning a gate electrode layer after forming the gate electrode layer on an upper surface of the insulating layer 14; forming the emitter holes 15 in the insulating layer 14; and forming the emitters 30 in the emitter holes 15. That is, the method of manufacturing the above field emission type backlight unit is very complicated.

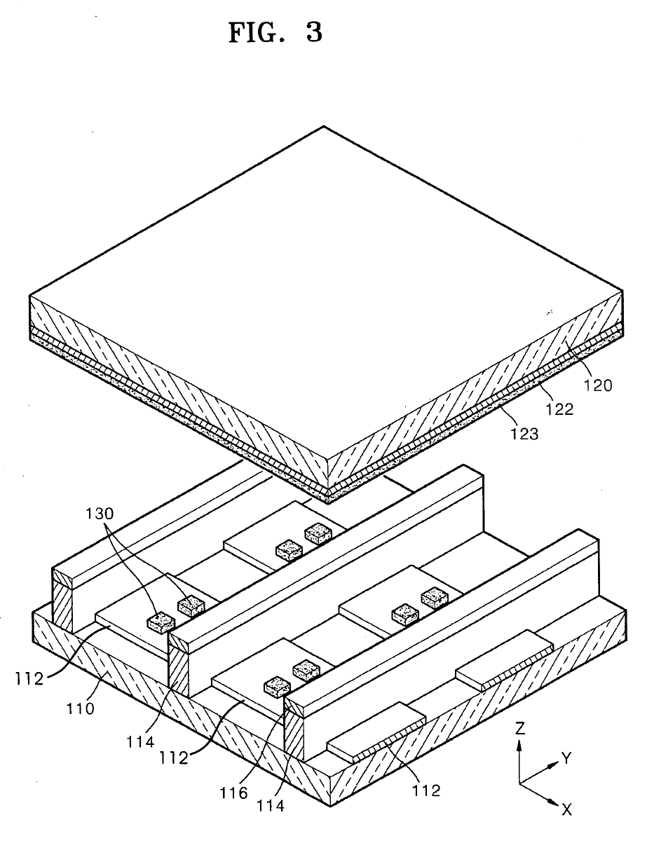

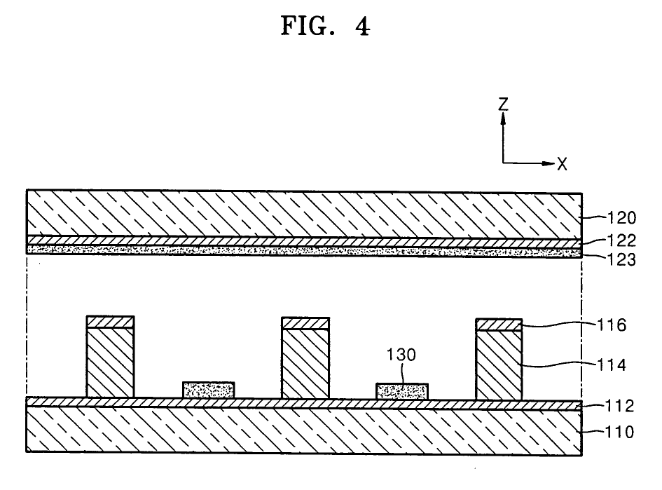

FIG. 3 is a partially exploded perspective view of a field emission type backlight unit according to an embodiment of the present invention, and FIG. 4 is a cross-sectional view of the field emission type backlight unit of FIG. 3. Directional and positional language is merely based on how each element is illustrated in the drawings.

Referring to FIGS. 3 and 4, a lower substrate 110 and an upper substrate 120 face each other separated by a predetermined distance. Here, the predetermined distance between the lower substrate 110 and the upper substrate 120 is maintained by spacers (not shown) formed therebetween. The lower substrate 110 and the upper substrate 120 may be usually glass substrates. A plurality of cathode electrodes 112 are formed on an upper surface of the lower substrate 110. The cathode electrodes 112 are formed parallel to each other, and can be formed of a metal or a transparent conductive material such as indium tin oxide (ITO).

A plurality of insulating layers 114 are formed having a line shape on upper surfaces of the lower substrate 110 and the cathode electrodes 112. Here, the insulating layers 114 may perpendicularly cross the cathode electrodes 112. The insulating layers 114 may be formed to a height of 3 to 10 μm, and to have a gap of 10 to 30 μm therebetween. The insulating layers 114 can be formed of a photosensitive or non-photosensitive insulating material. If the insulating layers 114 are formed of a photosensitive insulating material, the cost of manufacturing can be reduced and manufacture of a large size backlight unit can be easier.

A plurality of gate electrodes 116 for extracting electrons are formed on each upper surface of the insulating layers 114. The gate electrodes 116 are formed along the upper surface of each insulating layer 114, and can be formed of a metal or a transparent conductive material such as indium tin oxide (ITO).

At least one emitter 130 is formed on each cathode electrode 112 between insulating layers 114. The emitter 130 emits electrons by applying a voltage between the cathode electrodes 112 and the gate electrodes 116. In FIG. 3, two emitters 130 are formed on each cathode electrode 112 between insulating layers 114, but the present invention is not limited thereto. That is, one, three, or more than three emitters can be formed on the cathode electrodes 112. The emitter 130 may be formed of an electron emission material having good electron emission properties. More specifically, the electron emission material can be formed of at least one material selected from the group consisting of carbon nanotubes (CNTs), ZnO (zinc oxide), amorphous carbon, nano diamond, nano metal wire, and nano oxide metal wire.

An anode electrode 122 is formed on a lower surface of the upper substrate 120, and a phosphor layer 123 is coated on the anode electrode 122. The anode electrode 122 can be formed of a transparent conductive material.

In the field emission type backlight unit according to the present embodiment, when predetermined voltages are applied to the cathode electrodes 112, the gate electrodes 116, and the anode electrode 122, electrons are emitted from the emitter 130 due to the voltage applied between the cathode electrodes 112 and the gate electrodes 116. At this time, when the insulating layers 114 are formed to a predetermined height of a straight line shape as in the present embodiment, the initial divergence angle of electrons is increased, and thus, spreading of the electrons can be increased. If the spreading of the electrons is increased, brightness and luminous efficiency of the backlight unit can be increased. The electrons, having a large initial divergence angle, proceed toward the anode electrode 122 and collide with the phosphor layer 123 to emit light.

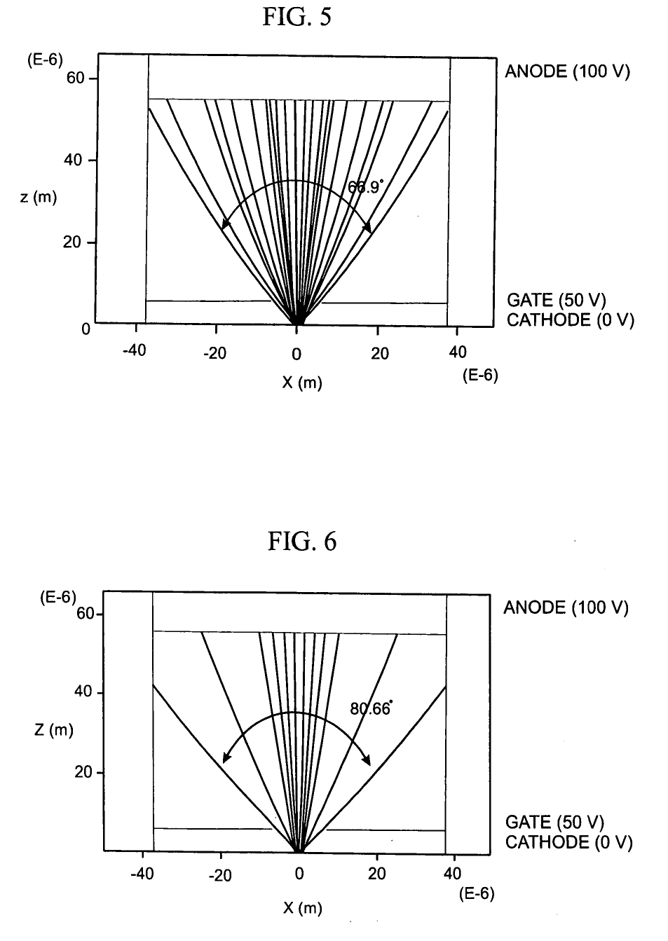

FIG. 5 is a schematic drawing showing initial divergence angles of electrons emitted from the emitter of an exemplary field emission type backlight unit and FIG. 6 is a schematic drawing showing initial divergence angles of electrons emitted from the emitter of a field emission type backlight unit according to an embodiment of the present invention.

In FIGS. 5 and 6, voltages of 0V, 50V, and 100V are applied to the cathode electrodes, the gate electrodes, and an anode electrode, respectively. Referring to FIGS. 5 and 6, it can be seen that the field emission type backlight unit according to an embodiment of the present invention, in which the insulating layers are formed in a line shape has a larger initial divergence angle than the exemplary field emission type backlight unit.

A method of manufacturing the field emission type backlight unit of FIG. 3, according to an embodiment of the present invention, will now be described.

FIGS. 7 through 14 are cross-sectional views illustrating a method of manufacturing a field emission type backlight unit according to an embodiment of the present invention. In FIGS. 7 through 14, a substrate 110 corresponds to the substrate 110 of FIG. 3.

Referring to FIG. 7, a plurality of cathode electrodes 112 are formed on the substrate 110. The substrate 110 may be usually a glass substrate. A cathode electrode layer (not shown) is deposited on the substrate 110. Then, cathode electrodes 112 may be formed by patterning the cathode electrode layer to a predetermined shaped. The cathode electrode layer can be formed of a metal or a transparent conductive material such as indium tin oxide (ITO). The cathode electrodes 112 can be formed in a stripe shape parallel to each other.

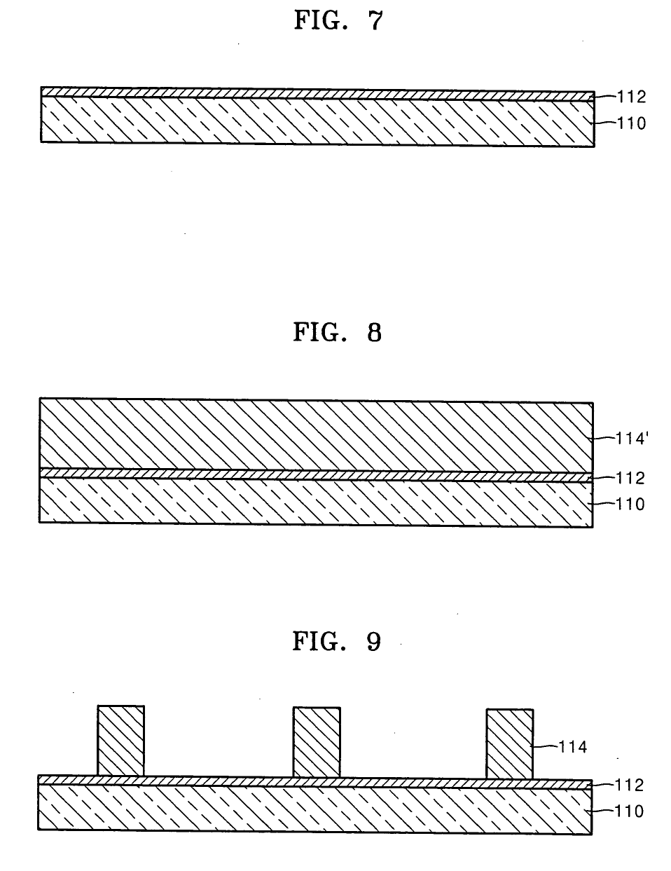

Referring to FIG. 8, a paste 114′ containing an insulating material is coated to a predetermined thickness on the substrate 110 to cover the cathode electrodes 112. The paste 114′ can include a photosensitive or non-photosensitive insulating material.

Referring to FIG. 9, a plurality of insulating layers 114 having a line shape are formed by patterning the paste 114′. At this time, the insulating layers 114 may cross the cathode electrodes 112. More specifically, when the paste 114′ is formed of a photosensitive insulating material, after patterning the paste 114′ using a photolithography process, the line shaped insulating layers 114 can be formed by baking the patterned paste 114′. In this way, when forming the insulating layers 114 using a photosensitive insulating material, the cost of manufacturing can be reduced and the manufacture of a large size backlight unit can be easier.

When the paste 114′ is formed of a non-photosensitive insulating material, a photoresist (not shown) is coated on the paste 114′ after the paste 114′ is coated on the substrate 110 and baked.

Next, after patterning the photoresist, the paste 114′ is etched to form the line shape insulating layers 114.

The insulating layers 114 can be formed to a height of 3 to 10 μm and to have a gap of 10 to 30 μm therebetween.

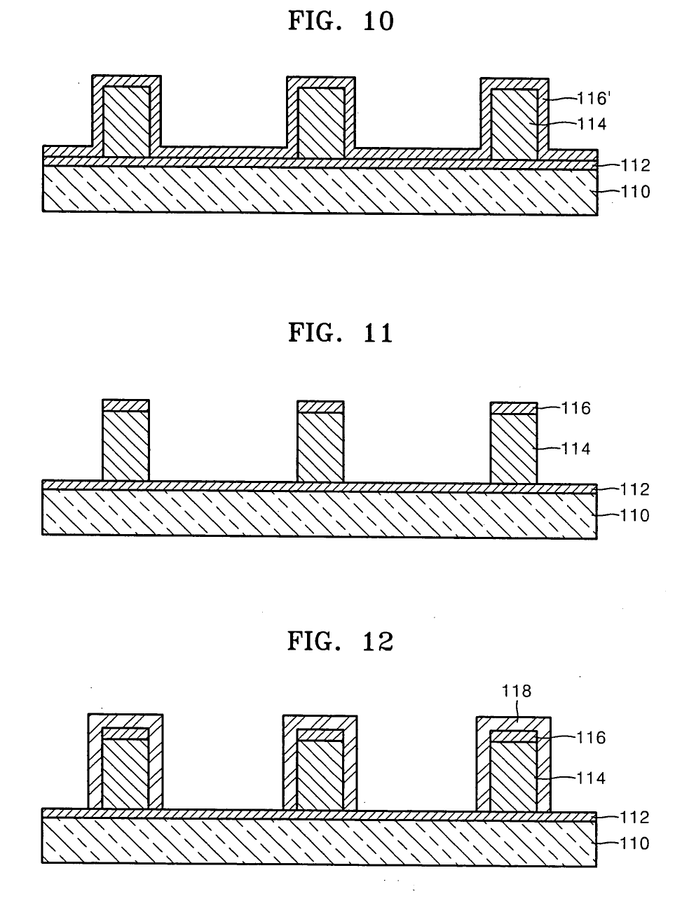

Referring to FIG. 10, a gate electrode layer 116′ is formed on the entire surface of the resultant product of FIG. 9 by depositing a predetermined conductive metal material on the entire surface of the resultant product of FIG. 9. The gate electrode layer 116′ can be formed of a material such as chromium (Cr). Referring to FIG. 11, a plurality of gate electrodes 116 are formed on upper surfaces of the insulating layers 114 by patterning the gate electrode layer 116′. Here, the gate electrodes 116 are formed along the upper surfaces of the insulating layers 114.

Next, emitters 130 (see FIG. 3) formed of an electron emission material are formed on the cathode electrodes 112 between the insulating layers 114. More specifically, referring to FIG. 12, after coating a photoresist on an entire surface of the resultant product of FIG. 11, the photoresist is patterned to a predetermined shape. A portion of the cathode electrodes 112, more specifically, the portion of the cathode electrodes 112 where emitters 130 will be formed in a subsequent process, between the line shaped insulating layers 114 are exposed through the patterned photoresist 118.

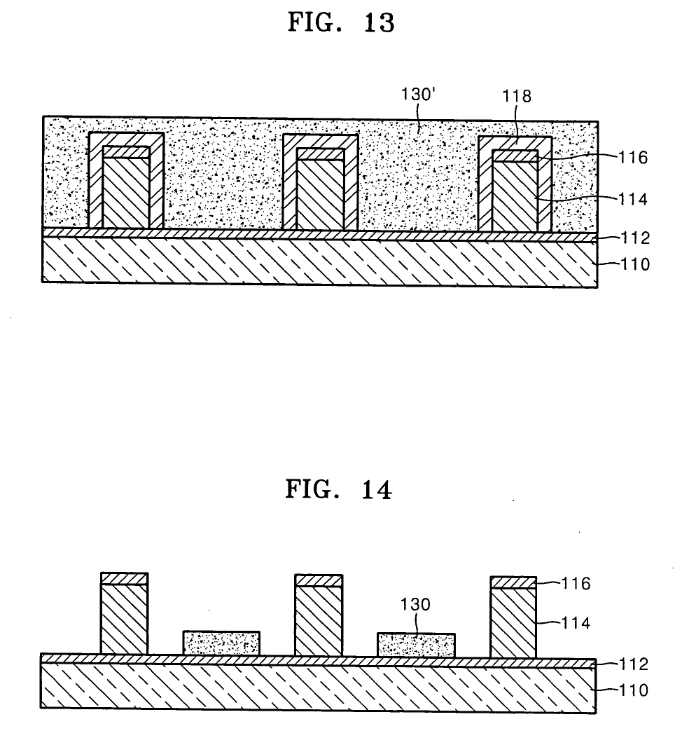

Next, referring to FIG. 13, spaces between the line shaped insulating layers 114 are filled by coating a paste 130′ containing an electron emission material on an entire surface of the resultant product of FIG. 12. Here, the electron emission material may be formed of a material having good electron emission properties. The electron emission material can be formed of at least a material selected from the group consisting of carbon nanotubes (CNTs), ZnO (zinc oxide), amorphous carbon, nano diamond, nano metal wire, and nano oxide metal wire. Next, the paste 130′ is selectively exposed by irradiating ultraviolet rays from a rear side of the substrate 110 using a backside exposure method. Next, the photoresist 118 and unexposed sections of the paste 130′ are removed using a developing agent, and thus, only exposed sections of the paste 130′ remain on the cathode electrodes 112 between the insulating layers 114. Then, the exposed sections of the paste 130 are baked. Thus, as depicted in FIG. 14, the emitters 130 are formed on the cathode electrodes 112 between the insulating layers 114. The emitters 130 can be formed to a height of 1 to 3 μm. In FIG. 14, one emitter 130 is formed on each cathode electrode 112 between insulating layers 114, but the present invention is not limited thereto.

The manufacture of a field emission type backlight unit according to an embodiment of the present invention is completed when an upper substrate 120, on which anode electrodes 122 (see FIG. 3) and phosphor layer 123 are formed, is coupled to the substrate 110, on which the cathode electrodes 112, the insulating layers 114, the gate electrodes 116, and emitters 130 are formed.

As described above, according to the present invention, the initial divergence angle of electrons emitted from emitters of a field emission type backlight unit can be increased by forming insulating layers formed in a line shape on a substrate on which cathode electrodes are formed. Accordingly, spreading of the electrons can be increased, thereby improving brightness and luminous efficiency of the field emission type backlight unit. Also, manufacture of the field emission type backlight unit is simpler than the conventional method.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A field emission type backlight unit comprising:
a lower substrate;
a plurality of cathode electrodes formed on the lower substrate;
a plurality of insulating layers formed in a line shape on the lower substrate and the cathode electrodes;
a plurality of gate electrodes formed on the insulating layers; and
at least one emitter formed of an electron emission material formed on each cathode electrode between the insulating layers.

2. The field emission type backlight unit of claim 1, wherein the cathode electrodes are parallel to each other, and the insulating layers perpendicularly cross the cathode electrodes.

3. The field emission type backlight unit of claim 1, wherein the insulating layers have a height of 3 to 10 μm.

4. The field emission type backlight unit of claim 1, wherein a gap between insulating layers is 10 to 30 μm.

5. The field emission type backlight unit of claim 1, wherein the insulating layers are formed of non-photosensitive insulating material.

6. The field emission type backlight unit of claim 1, wherein the insulating layers are formed of photosensitive insulating material.

7. The field emission type backlight unit of claim 1, wherein the gate electrodes are formed along upper surfaces of the insulating layers.

8. The field emission type backlight unit of claim 1, wherein the emitter has a height of 1 to 3 μm.

9. The field emission type backlight unit of claim 1, wherein the electron emission material is formed of at least one selected from the group consisting of carbon nanotubes (CNTs), ZnO (zinc oxide), amorphous carbon, nano diamond, nano metal wire, and nano oxide metal wire.

10. The field emission type backlight unit of claim 1, further comprising:
an upper substrate spaced a predetermined distance from the lower substrate;
an anode electrode formed on a lower surface of the upper substrate; and
a phosphor layer formed on a lower surface of the anode electrode.

11. A method of manufacturing a field emission type backlight unit, comprising:
forming a plurality of cathode electrodes on a substrate;
forming a plurality of insulating layers formed in a line shape on the substrate and the cathode electrodes;
forming a plurality of gate electrodes on the insulating layers; and
forming at least one emitter formed of an electron emission material on each cathode electrode between each insulating layer.

12. The method of claim 11, wherein the cathode electrodes are formed by depositing a cathode electrode layer on the substrate and subsequently patterning the cathode electrode layer.

13. The method of claim 11, wherein the cathode electrodes are parallel to each other.

14. The method of claim 11, wherein the insulating layers perpendicularly cross the cathode electrodes.

15. The method of claim 11, wherein the insulating layers have a height of 3 to 10 μm.

16. The method of claim 11, wherein the insulating layers have a gap of 10 to 30 μm therebetween.

17. The method of claim 11, wherein the insulating layers are formed by coating a paste containing an insulation material on the substrate to cover the cathode electrodes and the substrate, and then patterning the paste into a line shape.

18. The method of claim 17, further comprising baking the patterned paste.

19. The method of claim 17, wherein the insulating layers are formed of photosensitive or non-photosensitive insulating material.

20. The method of claim 11, wherein the gate electrodes are formed along upper surfaces of the insulating layers.

21. The method of claim 11, wherein the gate electrodes are formed by depositing a gate electrode layer to cover the substrate, the cathode electrodes, and the insulating layers and then patterning the gate electrode layer.

22. The method of claim 11, wherein the emitter has a height of 1 to 3 μm.

23. The method of claim 11, wherein the electron emission material is formed of at least one selected from the group consisting of carbon nanotubes (CNTs), ZnO (zinc oxide), amorphous carbon, nano diamond, nano metal wire, and nano oxide metal wire.

24. The method of claim 11, wherein the forming of the emitter comprises:
forming a photoresist which covers the substrate, the cathode electrodes, the insulating layers, and the gate electrodes but exposes a portion of the cathode electrodes between insulating layers;
filling spaces between the insulating layers corresponding to the exposed portions of the cathode electrodes using a paste that comprises an electron emission material;
exposing a section of the paste from a rear side of the substrate;
removing the photoresist and unexposed sections of the paste; and
baking the exposed sections of the paste that remain on the cathode electrodes between the insulating layers.
